(19) United States
(12) Patent Application Publication
(10) Pub. No.: US 2011/0270659 A1
(43) Pub. Date: Nov. 3, 2011

(54) Method for increasing sales at an automobile dealership by providing instantaneous personalized inventory price quotes or payment estimates via internet

(76) Inventor: Michael Emerson Crites, (US)

(21) Appl. No.: 12/662,664

(22) Filed: Apr. 28, 2010

(51) Int. Cl. G06Q 30/00; G06Q 50/00

(52) U.S. Cl. 705/14.24

(57) ABSTRACT

This invention allows a customer to browse the inventory on a dealership's website and obtain an immediate personalized price or payment quote without further interaction from dealership personnel.

### CROSS REFERENCE TO RELATED APPLICATIONS

This application relates to U.S. Pat. No. 7,529,694, entitled: “Method for increasing sales of vehicles at an automobile dealership using a hand held scanner and a data base link,” which is incorporated herein by reference in its entirety for all purposes. This application also relates to U.S. Provisional Patent Application 61/214,809 filed Apr. 29, 2009 entitled: “Method for increasing sales at an automobile dealership by providing instantaneous personalized inventory price quotes or payment estimates via the internet,” which is incorporated herein by reference in its entirety for all purposes.

### BACKGROUND OF THE INVENTION

This invention pertains to quotations regarding the sale or financing of vehicles at an automobile dealership by way of the internet. More specifically, enabling the customer to quickly obtain a reliable estimate of his expected monthly payment obligation or net sales price of any given vehicle in a dealership's inventory or dealership virtual inventory while taking into account the complexity of available manufacturer or dealer incentives as well as the personal financial factors of the customer without having to repeatedly check with the dealership for price or payment quotes for each vehicle for which he is interested.

### PRIOR ART

It is frequently a tedious and difficult process for a customer at an automobile dealership to obtain a reliable estimate of his expected monthly payments for a particular car, truck, or sport utility vehicle while browsing the vehicles that he may see on a dealership's internet site. It is not even an easy thing to be able to get a quick straight forward answer to the best available straight sales price as in a cash sale particularly for a new car, particularly when an original answer may result in a sales price unsatisfactory for one's budget and a second or third query on a different vehicle is required. When financing, often there is a multitude of choice involving financing opportunities for that vehicle, including manufacturer's special APR, annual percentage rate, incentives, cash rebate opportunities, cash rebate and low APR incentive split opportunities, private coupons, lease opportunities, balloon payments, dealer arranged bank financing, and the customer's own source bank or credit union financing. Rates and terms may vary according to the year of the vehicle, whether the vehicle is new or used, the amount financed, the term or the loan, the percent of down payment, the manufacturer's incentive programs at that time, whether a used car has been certified by a manufacturer's program, dealership profit goals in the finance department, as well as the customer's own credit rating, along with other factors. It is a common practice to offer a payment calculator on a dealership website, but it is left up to the customer to enter such items as the projected sales price and down payment or the amount financed as well as the interest rate and term. The customer is left on his own to discover which alternative offering of a cash rebate or low APR offer, if available, would suit him best in lessening his monthly payment obligation. The customer does not have a realistic sense in real time, as he browses the dealership's inventory of new and used cars on the website, what his estimated monthly payment range would be from car to car. It is also true that the customer may face obstacles and time delays even to determine the actual net cash sales price of a vehicle offered for sale, particularly in view of any special incentives for which he individually is eligible for at that point in time. Common practices by most dealerships either call for a routine markup over dealer invoice formula which is then recalculated by hand to account for the ever varying manufacturer incentive programs, or more often, a practice of having dealership personnel respond individually to each customer one by one on each request for a quote on each vehicle which may take place in a time frame of interchanges between customer and dealership over hours or days. Moreover, dealerships typically have an infuriating difficulty consistently obtaining full and truthful customer contact and lead information. Because of the anonymity of the internet, many internet leads are bogus, misleading, and unreachable. However, since customers would necessarily have to divulge a certain amount of full and truthful contact information in order to properly utilize the accuracy of the internet Payment Ranger™ system, dealerships would necessarily be getting a much better quality of lead. A system that allows a customer to browse a dealership's inventory on the internet and quickly recognize the unique vehicle identification number of any vehicle for sale at the dealership and then, after accessing the appropriate applicable data base tables, calculate among all the various alternatives and then choose and display the preferred monthly payment estimate or net cash sales price specific for that customer would be of great value to both the customer and the selling dealership. Additional vehicle sales are anticipated at dealerships offering their customers a choice of using this invention because greater numbers of customer would be expected to visit the website of a dealership who offered an easier, more straight forward shopping experience, and the quality of interaction between the customer and the dealership would also be enhanced.

### OBJECTS AND ADVANTAGES

Customers who plan to finance their vehicle may browse a dealership's inventory on the dealership's website, with or without an actual finance company's pre-approval, and see an estimate of their expected monthly payment individualized for themselves alone for each vehicle as they compare.

Customers who plan on paying cash for a vehicle may browse the inventory on a dealership's website and see an expected net sales amount that has been individualized for themselves and which includes the benefit of all rebates, coupons, discounts, and incentives on each vehicle that they compare.

Customers may easily ascertain the difference in their price or payment for a new introductory year model as compared to a current, or last year's model. This is especially significant not only as year end rebate or APR incentives change with model year rollovers, but also very much so in regards to leasing values in relation to monthly payment effects.

Customers may easily ascertain the difference in their price or payment for a new vehicle as compared to a similar used vehicle. This is extremely important for those customers who have weak or damaged credit who may find that a new vehicle may be essentially about the same cost per month as a similarly priced several year old used vehicle in many cases due to some new car manufacturer financing APR incentive programs.

Customers may easily ascertain the difference in their price or payment for a vehicle with basic trim level compared to a similar vehicle with a higher trim level and more options. Being able to quickly compare the net difference in sales price or monthly payment amount allows the value of the alloy wheel package or sunroof to be put in perspective more readily.

Customers may easily ascertain the difference in their payment if they increase the amount of their down payment, or renegotiate their trade allowance. Sometimes an extra 1,000.00 down payment makes much more difference than what the pro rata proportion would suggest, if the higher down payment changes the customer to a better credit tier the results can be very significant.

Dealerships may make immediate adjustments to the quoted net sales price of each of their vehicles by reflecting the changes of factory rebates that occur once in the Factory Incentives database table rather than by making the changes one by one on each individual vehicle. This is currently one of the big reasons why dealerships do not provide a net sales price on their internet web sites for new cars as they do currently for their used car inventories. If the dealership were to offer for example a Ford Focus for example that listed with a Manufactured Suggested Retail Price of 18,105.00 for 16,705.00 after figuring a 900.00 discount and a 500.00 rebate and then the rebate changed to 1000.00, the dealership would then be overpriced by 500.00. Worse, if the rebate went away, the dealership would be under priced by 500.00. Consequently, dealerships typically are not easily able to keep track of the net sales price of all new cars in stock because manufacturer rebates and incentives may change rapidly, on occasion more than daily. By effecting the change by body code once in the Factory Incentives table, all net sale prices to individual cars are immediately applied.

Dealerships may make immediate adjustments to the sales price of any vehicle or vehicle line by making the change in the Vehicle database table. Dealerships may raise or lower the point at which the demand and supply curve meet in order to maximize profit levels.

Dealerships can be more certain that their entire inventory will be correctly quoted at each sales opportunity. Allowing the customers fuller chances to be easily and quickly quoted on everything that the dealership sells with less steering by sales persons will increase inventory turn and ensure less old age inventory in the long run.

Dealerships will increase customer satisfaction by being able to immediately address customer inquiries as to payment or price.

Customers and Dealerships can both recognize overlooked opportunities and take advantage of all available factory incentives to the fullest. There are at times so many different programs that may overlap that even the best dealership sales tower manager may miss a way to put a deal together that this system will make clear.

Customers may tend to browse the Dealership's inventory more thoroughly, thus increasing the chance that they will find a vehicle in their price or payment range that they like. Because shopping will be easier and less hassle, customers are expected to spend more time at the dealership's website compared to previous shopping experiences elsewhere thus increasing the likelihood that they will eventually come across something that suits their fancy.

By tracking customers shopping and browsing patterns, dealerships will be able to precisely monitor which vehicles are of interest to which customers, both individually and collectively, so as to better achieve marketing successes.

Dealerships will increase their website traffic by offering a fun and easy to use shopping tool. Compared to current methods of internet automobile shopping, this is the only method and system that provides immediate customized quotes and estimates on the dealerships entire true and virtual inventory.

Dealerships will more likely obtain full, factual, and useful information about the customers who are shopping on their dealership website. In order for full functionality and the best potential of the Payment Ranger™ on line application to be realized, the customer knows that it is necessary for him to input a certain amount of truthful contact information in order for the payment estimates to be valid and the price quotes to be valid. Therefore it is expected that the quality of the internet lead of customers using this application at a dealership website will be superior to a typical internet lead.

### DETAILED DESCRIPTION

In brief, this invention is similar in some basic structure to the related U.S. Pat. No. 7,529,9694, which allows a customer to use a handheld device to recognize the vehicle identification number of a vehicle for sale at a dealership's lot. The handheld device then transmits over a wireless local area network the chosen vehicle identification number to a host computer server which accesses each of the hosted database tables necessary for calculating the customer's monthly payment estimate. In this invention, a specific URL, uniform resource locator, address is sent to the customer after the customer fills out and submits a basic questionnaire to the dealership. This URL is specific and customized to the individual customer regarding his own individual credit qualifications and eligibility for special sales programs. It is not always necessary for the customer to begin with a questionnaire and his own specific website in order to use this application at a dealership. The dealership in fact may maintain the availability of the application common in use for all customers for net sales prices with a suggestion such as “This is our worst price, fill out the questionnaire to see our very best price or payment.” This would allow the customers to become familiar with the ease and comfort of the shopping tool before committing to their personal data. The customers would then be invited to complete full information as defined by each dealership such as, but not restricted to or defined by, name, address, phone numbers, e-mail address, social security number, employment, income, bank information, previous dealership experience, vehicles owned, etc. Depending upon customer permissions and requests, a hard or soft credit bureau pull perhaps would then be completed and a customized URL link for either price or payment estimate would then be sent to the customer. In one working application, the customer is advised to slightly reduce the viewing size of both the dealership's inventory website and the Payment Ranger URL so that they can be seen side by side on the customer's computer monitor. Whenever the customer sees a vehicle that interests him while looking through the dealership's online inventory, he can simply copy and paste the VIN onto the Payment Ranger URL and then hit enter or return on that web address. The dealer's best shopping suggestion for the customer's monthly payment amount, net cash sales price, or both would then be immediately displayed for immediate consideration by the customer.

In another working demonstration model of this system, the customer simply clicks on the vehicle identification number of any car, truck, or sport utility vehicle that interests him that is displayed on the dealerships website. A popup box then opens which displays the customized individualized preferred price or payment for that vehicle along with intended verbiage for completing the transaction or appointment event.

An intended design plans to allow the customer's cursor to simply hover over the desired vehicle identification number on the dealership's website to display the individualized net sales price or payment. This invention does not concern the advances in website design as regards to framing, squeeze back, overlay, or how to enclose or display third party content within a dealership website but rather the third party content itself.

In the currently preferred embodiment of the system, similar to the current working model, the system consists of the following basic devices:

A computer server, desktop computer, or similar assembled components with available hard drive or other accessible data storage sufficient to store all the desired data tables is used. The computer has sufficient processing speed to quickly look up the selection of required data in the data tables and to then perform the mathematical calculations necessary for quick and accurate results. A personal computer with a 1 GHZ AMD Athlon processor, 512 MB of RAM, a 6 GB hard drive, a network card, and a Windows XP professional operating system with Service Pack 2 is adequate for use as a computer server with this invention, though other computer server arrangements may also be acceptable.

Multiple data storage tables are used. Minimum amounts of data may be stored for this invention to operate at a less complex level of functionality. The data storage tables would typically consist of at least a Vehicle data table, APR tables for conventional financing, and a Factory Incentives table, and a Customer data table.

The Vehicle data table would typically consist of at least the VIN, vehicle identification number, or other unique identifying label, a notation of whether the vehicle is new or used, and the dealership selling price of the vehicle. For enhanced capability to customize the use of this invention for adaptability at the dealership, the Vehicle data table would also consist of identifiers indicating if the vehicle was a new dealer demonstrator or a certified used vehicle, the Manufacturer's Suggested Retail Price, MSRP, the invoice price of new vehicles, the current dealer cost figures of both new and used vehicles, the X plan indicated selling price, the A plan indicated selling price, the amount of cash or true customer trade equity required for individuals with very poor credit, the number of days that the vehicle has been in the dealer inventory, the current odometer mileage of the vehicle, the trim level, the vehicle color, wheelbase, as well as other additional details as may be desired with future enhancements.

The APR tables for conventional financing allow the dealership to input the preferred term and annual percentage rate to be used for each individual tier of customer credit rating depending on the year of the vehicle and whether the vehicle is new or used. Typically in the marketplace, older vehicles are financed at a shorter term and a higher interest rate than newer vehicles. Annual percentage rates are typically higher for those individuals with poor credit than for those individuals with excellent credit.

The Factory Incentives table is populated by the dealership with the up to date information of the Manufacturer's rebates and low APR offers, as well as other incentives that may be available to purchasers or lessees of a selected year and model vehicle. Typically the incentives are often a choice of a customer cash offer, or rebate, a factory associated financing offer at a below market interest rate, or a combination of a rebate and a low interest rate offer. Lease incentives are often of a somewhat similar basic structure. Frequently the Factory Incentives may be particular to a specific body type within a vehicle line, for example a different incentive for a coupe instead of a sedan. It is also common for the Factory Incentives to vary with the engine of the vehicle chosen. This invention organizes the data in the Factory Incentives table by select digits of the vehicle identification number. For many manufacturers, the fifth, sixth, and seventh digit represents the car line, series, and body style, or the truck line, series, and body style of the vehicle. The eighth digit is typically the engine code. The tenth digit is the year model of the vehicle. This invention organizes the information in the Factory Incentives table by the year and fifth, sixth, seventh, and sometimes eighth digit of the vehicle identification number, as well as the credit tier level of the individual customer. For example, Factory Incentives for the 2010 Ford Edge modes, excluding the SE All Wheel Drive, may be referenced by the body codes K3G, K3J, K4J, K3K, K4K, K3A, K4A. It is not important to reference the eighth digit, engine code, in this case because that information does not affect the amount of the offerings of factory incentives. For customers with A credit, excellent credit, the customer has a choice of a total of $3,000 in combined customer cash as one offer. The second choice for a customer with A credit is financing at 1.9% APR for a term of 72 months, which is an offer that is below conventional market rate financing for a customer with A credit. The third offer 3.9% APR for a term of 72 months. For a customer with B credit, or good credit, the factory incentive choices would be $3,000 combined customer cash or financing at 3.9% for a term of 72 months, or $1,000 and 5.9% for 72 months. A customer with C credit, or somewhat marginal credit, would in this case be offered a customer cash opportunity of $3,000 or financing at 5.9% for a term of 72 months, or $1,000 and 7.9% for 72 months. If expected to be approved by Ford Motor Credit Corporation with a D credit tier a customer would have a choice of $3,000 customer cash, 15.9% APR for 72 months or $1,000 and 17.9% for 72 months. Depending on the current prevailing factory incentives offers, the current prevailing rates and terms for conventional financing, the customer's credit tier, the customer's cash down payment, positive or negative trade-in equity, and the amount of coupons and discounts which all determine the customer's final amount to be financed, any of the various factory incentive offerings may result in the customer's preferred payment estimate, or lowest payment estimate, being chosen at one time or another. By making multiple calculations and then comparing the results, this invention determines the preferred payment estimate, typically the lowest payment estimate, although other calculated result choices could be selected as preferred, for each customer while taking into account the many variables that affect each individual customer.

The Customer Data table consists typically of at least the amount of the customer's cash down payment, the customer's trade-in equity, and the customer's credit level tier. Additional prompts that allow this invention to identify special discount or cash coupons that would uniquely apply to a particular customer sub grouping, eligibility for special plan pricing, specifically and particularly named financing rates and terms such as may be available to the customer from his credit union or other outside source financing, and a selection to allow for a net cash price after the applied benefit of all cash rebates and coupons to be displayed rather than a payment range for those customers not interested in financing arrangements are preferred, but not necessary. An option to include an estimate of the titling tax, tag and title fees, processing fee, and other fees in the amount financed for the payment estimate may be included as well, although it is not necessary.

The Dealership Options Data table, if included, would provide for dealership prompts to manipulate data fields in order to allow varying profit levels for each year model and vehicle line. Other options could include offering an exceptionally low price for old age vehicle inventory, or larger discounts for overstocked color or trim lines. It is expected that many other dealership prompts may become useful and desired depending on the needs of the individual dealership. The Dealership Options Data table is preferred, but not necessary.

Once a specific VIN is chose, the custom URL transmits the VIN to the Computer Server over the internet. If the Computer Server finds the VIN of the chosen vehicle in the Vehicle Data Table, several different mathematical calculations are then typically performed and results compared one to another to deduce the result which results in the preferred monthly payment amount.

If the vehicle is labeled as used, then Selling Price is determined by applying any adjustments as may be noted in the Dealer Options Data Table to the List Price, and then applying the positive or negative subtotal of the customer's cash down payment and trade-in equity to arrive at an amount to be financed. The annual percentage rate and term of the financing is found in the APR Data tables for used vehicles referenced by the customer's credit rating tier. The mathematical calculations are then performed to arrive at a monthly payment result. In the case of a vehicle labeled as used, that monthly payment result is then multiplied by 101%, and then both the monthly payment result and 101% of the monthly payment result are rounded upwards to the nearest whole dollar. The payment range that has been calculated, as well as the vehicle identification number, is then transmitted to the internet server for display to the customer. For example: Payment Range, 330-334, 2FMDK3JC0ABA44968.

If the vehicle is labeled as certified used, then the Selling Price is determined by applying any adjustments as may be noted in the Dealer Options Data Table to the List Price, and then applying the positive or negative subtotal of the customer's cash down payment and trade-in equity to arrive at an amount to be financed. The annual percentage rate and term of the financing is found in the APR Data tables for used vehicles referenced by the customer's credit rating tier. The mathematical calculations are then performed to arrive at a monthly payment result. After determining the amount to be financed, the annual percentage rate and term of the financing is found in the APR Data tables for certified used vehicles referenced by the customer's credit rating tier. Some manufacturer's certified used vehicle programs establish distinct annual percentage rates and terms depending on the model of the vehicle. In the case of such existing programs, the Dealer Options Data table would include, by body code, the interest rate or term adjustments available for those certified used vehicles. Then a second set of mathematical calculations are performed to arrive at a monthly payment result. The monthly payment result from each of these two methods is then compared, and the lower result is selected. That monthly payment result is then multiplied by 101%, and then both the monthly payment result and 101% of the monthly payment result are rounded upwards to the nearest whole dollar. The payment range that has been calculated, as well as the vehicle identification number, is then transmitted to the internet server for display to the customer.

Many manufacturers offer the customer a choice of incentive programs when purchasing a new vehicle. Typically, these offers vary by the year of the vehicle as well as the model, body type, and vehicle engine. Typically the customer may often choose from a stand alone cash rebate, also called customer cash, or from a stand alone low interest rate offer, or from a combination incentive which may include a smaller cash rebate offer than the stand alone cash rebate offer as well as a low interest rate offer that is not quite as low as the stand alone low interest offer. The low interest rate offerings in all the incentives typically vary somewhat with the customer's credit tier. Depending on the amount of cash down payment, net trade equity, discounts, coupons, and any other reductions in the final amount to be financed on the vehicle as well as importantly the specifics of the low interest rate offers compared to other financing alternatives as determined by the customer's credit tier, any of the several alternatives of manufacturer incentives may result in lower or preferred payment estimate at a given time.

If the vehicle is labeled as new, then the Selling Price is determined by applying any adjustments as may be noted in the Dealer Options Data Table to the List Price, and then applying the positive or negative subtotal of the customer's cash down payment and trade-in equity to arrive at an amount to be financed. The amount financed is then further adjusted by applying the dollar amount of any dealer cash programs, if any, that are to be applied to the customer's purchase price. The amount financed is then reduced by the amount of any special cash coupons to which the customer may be entitled, such as military, college, or other association or group associations. From this further subtotal of the amount to be financed, the eligible cash rebate from the Factory Incentives data table is then applied, and the payment estimate is calculated using the applicable information from the APR data tables. From the earlier subtotal, the payment estimate is again calculated, this time using the applicable information from the Factory Incentives data table of the stand alone low APR financing. From the earlier subtotal, the payment estimate is again calculated using the applicable information from the Factory Incentives data table of the combination offer of a cash rebate and low APR financing. The three results are compared, and the preferred result, typically the lowest payment estimate, is then ranged upwards one percent and then rounded up to the nearest whole dollar amounts. The preferred result is then transmitted to the internet server for display to the customer.

When lease estimates are also desired, the method used is to perform the same type of multiple calculations to determine the preferred result for display to the customer.

Although other vehicle identifiers, such as stock numbers, may be used, in the preferred embodiment of this invention the VIN is used to reference the vehicle to the Vehicle Data table as well as throughout the system in referencing data such as that in the Factory Incentives Data table.

To begin use of this invention, a dealership employee would typically input the available customer data for a specific customer inquiring via the internet into the Customer Data table. A unique digit identifier is then activated for that customer, and the unique identifying digit is entered as a log on to begin this invention processes. Because each customer has a unique digit identifier, multiple customers may use this invention. A customer's information may be edited within the Customer Data table. The customer's unique identifying digits are then reactivated for further use of this invention.

A HTML, hypertext markup language, page is created which contains a form. This page is accessed by the customer on the internet by way of a URL, uniform resource locator, containing such unique digit identified for that customer. In the current iteration of this invention, which works very adequately as tested, the customer would format the screen size of the Payment Ranger URL to a smaller, narrower display on his computer screen while displaying a dealership's internet website adjoining in a larger screen window. The customer then may browse the entire inventory that is posted online of the automobile dealership, and then whenever he finds a vehicle that interests him, to simply copy and paste that VIN of the vehicle from the dealership website to the Payment Ranger URL using the copy and paste tools within typical Windows software and other assorted computer programs. Other identifiers, such as stock numbers, than the VIN may be used within this invention, but for avoiding expected possible problems of mislabeling vehicles and to take best advantage of some of this invention's features the use of the VIN is highly recommended. Once the customer then activates that Payment Ranger URL, the data then posts to the server which then begins the process of obtaining the price or payment estimate described previously for display to the customer. The process consists of a PHP, hypertext preprocessor, version of the Payment Ranger PDA client. It functions very similarly to the actual PDA version, though the code language is written slightly differently to accommodate the requirements of the internet worldwide web usage. The PHP version of the Payment Ranger client communicates with the internal Payment Ranger functions, which are responsible for calculating the price or payment ranges, and display the price or payment ranges to the customer in their web browser.

Once the customer has selected a vehicle which interests him, he selects “SAVE” on the URL screen, selecting as well an appointment date and time. The selected vehicle then may be made ready through the detail department at the dealership so as to present a fresh and ready appearance when the customer arrives for the final delivery event or physical inspection and test drive. The customer input data as well as the mathematical calculations that were used to obtain the preferred payment estimate on each vehicle are available for review by either the customer or the dealership staff.

An additional embodiment to this invention would entail encoding the Payment Ranger Internet program directly into the website so that a customer would be able to obtain their customized price or payment quotes without the use of an additional URL.

An additional embodiment to this invention would allow its use at other dealerships than motor vehicle dealerships, such as recreational vehicle dealerships, motorcycle dealerships, boat dealerships, and airplane dealerships.

An additional embodiment to this invention, whether actualized in person or by way of the Internet, would be in the field of real estate sales. Similar data tables would be set up taking into account such diverse variables as real estate property tax rates which vary may vary on locality, private association fees, VA or FHA loan rates and fees, private mortgage insurance premiums, which may vary on loan to value ratios, as well as many other factors such as varying interest rates and terms based on credit ratings and homebuilders subsidies. Shoppers could enter street addresses or Multiple Listing Service identification numbers to quickly discover their own actual expected monthly obligation. Since down payment amounts tend to be static, but ratios tend to fluctuate depending upon sales prices, special loan opportunities and private sale offers could provide unique values when real estate shopping in this manner and could certainly be exciting.

An additional embodiment would be to allow customers browsing furniture stores to quickly and easily see their expected monthly payment as they added or substituted furniture groups, suites, or occasional pieces while decorating their homes.

An additional embodiment would allow lending institutions to capture more fresh business while also facilitating more point of purchase sales at boat, home improvement, or recreational vehicle shows. Customers would pre-qualify at an entrance location by either a hard credit bureau inquiry or even a soft inquiry based upon just their name and address and then use the Payment Ranger™ to browse the boat or RV show and immediately find the price or payment opportunities available to them based on their credit ratings, expected down payment, and the available sale pricings.

An additional embodiment to this invention would provide for a specific lender to arrange for coordination of inventory listings among multiple dealerships. Once a customer became registered and pre-approved by such a lender, then the customer could browse among multiple dealerships offerings and instantly see their competitive best shopping suggestion for their individual monthly payment range displayed with many manufacturer brands from which to choose. The lender could potentially increase their customer base as well as customer satisfaction.

An additional embodiment to this invention would display for the customer all calculation choices, not just the preferred choice, and/or display a full financial disclosure at the time of each payment estimate.

It is anticipated that many diverse applications of this invention will become obvious as diverse fields of commerce are considered.

In general, the means and method for increasing sales of vehicles at an automobile dealership by providing instantaneous personalized price or payment quotes may take other forms from that which has been thus far described. While some of the expected alternative embodiments have been described, those familiar with the art to which this invention relates will recognize various alternative designs and embodiments for practicing the invention. These alternative embodiments are within the scope of the present invention. The scope of the present invention is defined by the claims and the allowable equivalents.

What is claimed is:

1. A method providing one or more customers browsing a dealership internet website an immediate, automatic, and preferred payment estimate or net sales price for one or more vehicles for sale, the method for each customer comprising:
recognizing a vehicle identification number for sale by the dealership by a get within the internet program, transmitting the vehicle identification number to a computer server preloaded with the vehicle data associated with the vehicle identification number, financing data, factory incentives data, dealership financial data, and the customer data, wherein the computer calculates a preferred payment estimate or net sales price for the vehicle using the vehicle identification number and the preloaded data, and wherein factory incentives are based on the vehicle year, credit tier of the customer, and identifying digits of the vehicle identification number; transmitting the payment estimate or net sales price for the vehicle to the internet and displaying to the customer; saving the payment estimate or net sales price for the vehicle within the internet program wherein the method may be repeated to save the payment estimate or net sales price for each vehicle recognized; terminating by the customer use of the internet browsing session by selecting a termination condition recognized by the application; and revealing subsequent to termination condition saved payment estimate or net price for one or more recognized vehicles to both the customer and dealership staff.

2. A system providing one or more customers browsing a dealership internet website an immediate, automatic, and preferred payment estimate or net sales price for one or more vehicles for sale, the method for each customer comprising:
recognizing a vehicle identification number for sale by the dealership by a get within the internet program, transmitting the vehicle identification number to a computer server preloaded with the vehicle data associated with the vehicle identification number, financing data, factory incentives data, dealership financial data, and the customer data, wherein the computer calculates a preferred payment estimate or net sales price for the vehicle using the vehicle identification number and the preloaded data, and wherein factory incentives are based on the vehicle year, credit tier of the customer, and identifying digits of the vehicle identification number; transmitting the payment estimate or net sales price for the vehicle to the internet and displaying to the customer; saving the payment estimate or net sales price for the vehicle within the internet program wherein the method may be repeated to save the payment estimate or net sales price for each vehicle recognized; terminating by the customer use of the internet browsing session by selecting a termination condition recognized by the application; and revealing subsequent to termination condition saved payment estimate or net price for one or more recognized vehicles to both the customer and dealership staff.
